(19) United States
(12) Patent Application Publication
(10) Pub. No.: US 2024/0294219 A1
(43) Pub. Date: Sep. 5, 2024

(54) SYSTEMS, DEVICES, AND METHODS FOR A MOBILE ROBOT SYSTEM

(71) Applicant: Sanctuary Cognitive Systems Corporation, Vancouver (CA)

(72) Inventors: Suzanne Gildert, Vancouver (CA); Hessam Maleki, Burnaby (CA); Tadas Mitkus, Vancouver (CA)

(21) Appl. No.: 18/591,490

(22) Filed: Feb. 29, 2024

Related U.S. Application Data
(60) Provisional application No. 63/449,132, filed on Mar. 1, 2023.

(51) Int. Cl. B62D 57/028; B60L 53/80; B60L 58/12

(52) U.S. Cl. CPC B62D 57/028; B60L 53/80; B60L 58/12

(57) ABSTRACT

A mobile robot system has a robot body attached to a mobile base. The robot body has a torso, a first robotic arm mechanically coupled to the torso, a first robotic leg, and a second robotic leg. The first robotic leg and the second robotic leg are controllably actuatable to enable the robot body to execute bipedal walking. The mobile base has a platform to receive a lower end of the first robotic leg and a lower end of the second robotic leg, at least one wheel and a controllable steering mechanism to enable the mobile base to travel both while the robot body is positioned on the platform and while the robot body is not positioned on the platform. The mobile base also has a plurality of components, at least one of which operable to support at least one function of the robot body.

### CROSS-REFERENCE TO RELATED APPLICATIONS

This application claims the benefit of U.S. Provisional Application No. 63/449,132 filed Mar. 1, 2023, the content of which is incorporated herein by reference.

### FIELD

The present systems, devices, and methods generally relate to a mobile robot system, and, in particular, relate to a mobile robot system having a bipedal humanoid robot and a mobile base.

### BACKGROUND

Robots are machines that can assist humans or substitute for humans. Robots can be used in diverse applications including construction, manufacturing, monitoring, exploration, learning, and entertainment. Robots can be used in dangerous or uninhabitable environments, for example.

Some robots are stationary robots. Stationary robots are not mobile and typically operate at a fixed location. Examples include stationary robots at a manufacturing plant.

Other robots are mobile robots. Mobile robots are capable of locomotion. Examples include mobile rescue robots, fire-fighting robots, and robots able to mimic human behaviour. Some mobile robots are self-propelled. Some self-propelled mobile robots are capable of autonomous motion.

Some mobile robots are wheeled robots. Other mobile robots are legged robots. Legged robots may be one-legged, two-legged, or many-legged. A two-legged robot is also referred to in the present application as a bipedal robot. A bipedal robot may be a humanoid robot, for example. Legged robots may be more challenging to implement than wheeled robots, but can provide advantages, for example, on uneven terrain, stairs, and other places requiring agility in motion, as well as for accessing places designed for human access.

### SUMMARY

A mobile robot system may be summarized as comprising a robot body, the robot body comprising a torso, a first robotic arm mechanically coupled to the torso, a first robotic leg, and a second robotic leg, wherein the first robotic leg and the second robotic leg are controllably actuatable to enable the robot body to execute bipedal walking. The mobile robot system may further comprise a mobile base comprising a platform to receive a lower end of the first robotic leg and a lower end of the second robotic leg, at least one wheel and a controllable steering mechanism to enable the mobile base to travel both while the robot body is positioned on the platform and while the robot body is not positioned on the platform, and a plurality of components, at least one component of the plurality of components operable to support at least one function of the robot body.

In some implementations, the robot body is capable of autonomous travel.

In some implementations, the mobile robot system further comprises a hydraulic system, wherein at least one component of the hydraulic system is housed in the robot body. The hydraulic system may be operable to cause a motion of at least one of the first robotic leg, the second robotic leg, and the first robotic arm. At least one of the plurality of components of the mobile base may be a component of the hydraulic system, the component of the hydraulic system hydraulically coupleable to the robot body.

In some implementations, the mobile robot system further comprises a controller operable to control an action of the robot body. At least one of the plurality of components of the mobile base may be the controller, the controller communicatively coupled to the robot body.

In some implementations, at least one of the plurality of components of the mobile base is a first primary electrical power source operable to provide electrical power to the mobile base. The robot body may further comprise a second primary electrical power source operable to provide electrical power to the robot body, a controller comprising at least one processor, and at least one non-transitory processor-readable storage medium communicatively coupled to the at least one processor, the at least one non-transitory processor-readable storage medium storing processor-executable instructions and/or data that, when executed by the at least one processor, cause the robot body to identify a low-power condition of the second primary electrical power source of the robot body, and, in response to identifying the low-power condition, establish an electrical communicative coupling between the first primary electrical power source of the mobile base and the second primary electrical power source of the robot body to recharge the second primary electrical power source of the robot body using the first electrical power source of the mobile base. The electrical communicative coupling between the first primary electrical power source of the mobile base and the second primary electrical power source of the robot body may be a tethered electrical communicative coupling between the mobile base and the robot body. The tethered electrical communicative coupling between the mobile base and the robot body may include an electrical cable. The electrical communicative coupling between the first primary electrical power source of the mobile base and the second primary electrical power source of the robot body may be a wireless electrical communicative coupling between the mobile base and the robot body. The wireless electrical communicative coupling between the mobile base and the robot body may be an inductive coupling.

The mobile base may further include a secondary electrical power source. The robot body may further comprise a second primary electrical power source operable to provide electrical power to the robot body, a controller comprising at least one processor, and at least one non-transitory processor-readable storage medium storing processor-executable instructions and/or data that, when executed by the at least one processor, cause the robot body to identify a low-power condition of the second primary electrical power source of the robot body, and, in response to identifying the low-power condition, exchange the second primary electrical power source of the robot body for the secondary power source of the mobile base.

The processor-executable instructions and/or data that, when executed by the at least one processor, cause the robot body to exchange the second primary electrical power source of the robot body for the secondary power source of the mobile base, may cause the robot body to walk to the mobile base. The processor-executable instructions and/or data that, when executed by the at least one processor, cause the robot body to exchange the second primary electrical power source of the robot body for the secondary power source of the mobile base, may cause the mobile base to travel to the robot body.

In some implementations, the mobile robot system further comprises a controller, the controller operable to control an action of the robot body.

In some implementations, the robot body further comprises a second robotic arm, the second robotic arm mechanically coupled to the torso.

In some implementations, the mobile base further comprises a propulsion system, the propulsion system operable to cause a motion of the mobile base.

In some implementations, the mobile base is capable of autonomous movement.

In some implementations, the robot body is configurable in a plurality of articulations, wherein the mobile base has at least one of a weight, a shape, or a measurable extent to ensure the robot body is stable for each of the plurality of articulations of the robot body.

### BRIEF DESCRIPTION OF THE DRAWINGS

FIG. 1 is a schematic drawing of a front view of an example implementation of a mobile robot system, in accordance with the present systems, devices, and methods.

FIG. 2 is a schematic drawing of an isometric view of the mobile robot system of FIG. 1, in accordance with the present systems, devices, and methods.

FIG. 3 is a schematic drawing of a front view of the robot body of the mobile robot system of FIG. 1, in accordance with the present systems, devices, and methods.

FIG. 4 is a schematic drawing of a front view of the mobile base of the mobile robot system of FIG. 1, in accordance with the present systems, devices, and methods.

FIG. 5 is a schematic drawing of the mobile robot system of FIG. 1 carrying a load, in accordance with the present systems, devices, and methods.

FIG. 6A is a schematic drawing of the robot body of the mobile robot system of FIG. 1 bending forwards, in accordance with the present systems, devices, and methods.

FIG. 6B is a schematic drawing of the robot body of the mobile robot system of FIG. 1 bending at the knee joints, in accordance with the present systems, devices, and methods.

FIG. 7A is a schematic drawing of another example implementation of a mobile robot system, in accordance with the present systems, devices, and methods.

FIG. 7B is a schematic drawing of an example implementation of a mobile robot system having a tethered electrical communicative coupling between the robot body and the mobile base, in accordance with the present systems, devices, and methods.

FIG. 7C is a schematic drawing of an example implementation of a mobile robot system having a wireless electrical communicative coupling between the robot body and the mobile base, in accordance with the present systems, devices, and methods.

FIG. 8 is a schematic drawing of an example implementation of a mobile robot system with the robot body of FIG. 1 in a seated position on a mobile base, in accordance with the present systems, devices, and methods.

FIG. 9 is a schematic drawing of an example implementation of portion of a hydraulically-powered robot, in accordance with the present systems, devices, and methods.

FIG. 10 is a block diagram of an example implementation of a system of components housed in a base of a mobile robot system (for example, the mobile robot system of FIG. 1, the mobile robot system of FIG. 7, or the mobile robot system of FIG. 8), in accordance with the present systems, devices, and methods.

FIG. 11 is a schematic diagram of an example implementation of a robot with an electrical power source, in accordance with the present systems, devices, and methods.

FIG. 12 is a block diagram of an example implementation of a power source exchange station, in accordance with the present systems, devices, and methods.

FIG. 13 is a block diagram of an example implementation of a robotic system with a robot and a power source exchange station, in accordance with the present systems, devices, and methods.

FIG. 14A is a flow chart of an example method of operation of a robotic system, in accordance with the present systems, devices, and methods.

FIG. 14B is a flow chart of an example method for exchanging a primary power source of a robot at a power source exchange station, in accordance with the present systems, devices, and methods.

### DETAILED DESCRIPTION

The following description sets forth specific details in order to illustrate and provide an understanding of various implementations and embodiments of the present systems, devices, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, devices, and methods.

A robot may be a humanoid robot, that is, having an appearance and/or a character resembling that of a human. A humanoid robot may be “humanoid” in its entirety or may have humanoid components (e.g., a torso, head, arms, and hands) coupled to non-humanoid components (e.g., a wheeled base). It may be advantageous for a humanoid robot to be a bipedal robot. Furthermore, it may be advantageous for the humanoid robot to be a) untethered (i.e., not physically coupled, tied, or fastened to anything), b) able to mimic the complex movements of humans, and c) free to move around its environment. In some implementations, it may be advantageous for the humanoid robot to be capable of autonomous movement and action.

The technology described herein includes systems and methods for a mobile robot system having a robot body and a mobile base. In some implementations, the robot body and the mobile base are capable of independent travel in environment. In some implementations, the robot body may be transported by the mobile base. In some implementations, the robot body is a bipedal humanoid robot. In some implementations, the robot body is a bipedal humanoid robot capable of walking, and of stepping on and off a platform on the mobile base. In some implementations, the mobile base is a mobile docking station to which the robot body can return for various needs that can include charging, data processing, servicing, and maintenance.

In some implementations, the robot body has an on-board battery used to provide electrical power to the robot body, and the mobile base has a battery with a similar or larger capacity than the on-board battery and which is operable to charge the on-board battery of the robot body. In the event of a low battery on-board the robot body, the robot body can travel to the mobile base which it can use as a docking station for charging. Charging can be performed using a tethered electrical communicative coupling between the robot body and the mobile base, or wirelessly, for example, by inductive charging between the platform on the mobile base and feet on the robot body. In some implementations, the mobile base carries a spare battery that can be exchanged with the battery on-board the robot body.

In some implementations, the robot body returns to the mobile base so it can have access to additional computing resources (e.g., processor and/or memory), and/or access to communications capability (e.g., secure, tethered-only communication).

The degree of mobility of the mobile robot system may vary. For example, some mobile robot systems may be constrained to move along a fixed track. Others may, for example, be capable of autonomous and unconstrained movement in their environment. The mobile base may be a wheeled mobile base. The base may carry various components in support of robot operation, for example, components of a hydraulic system, a controller, computing resources, a battery, an electric motor, etc. The base may serve as a mobile ancillary unit capable of carrying components that would otherwise be too bulky or heavy to include in the robot.

An advantage of a bipedal robot is that it can bend forward to pick up an object, for example. In some implementations, a bipedal robot is able to articulate its legs and torso at one or more joints to interact with the ground, and with objects on the ground or low to the ground. For example, a bipedal robot may be able to bend the torso, as well as bend at the waist, the hips, the knees and/or the ankles. This capability can increase the range of work that can be assigned to the robot. In some implementations, the robot body is an autonomous walking biped robot.

In some operational scenarios, where the robot body needs to travel to a destination outside the robot body's walking range, or needs to get to a destination faster than the robot body could by walking, then the mobile robot system can arrange for the robot body to be transported to the destination by the mobile base. For example, the mobile robot system can summon the mobile base to the robot body whereupon the robot body can step onto the mobile base and be transported to the destination in a standing or a seated position. In such implementations, navigation of the combined robot body and mobile base system may be controlled by the robot body (i.e., the robot body may steer the mobile base) or by the mobile base (i.e., the mobile base may steer itself).

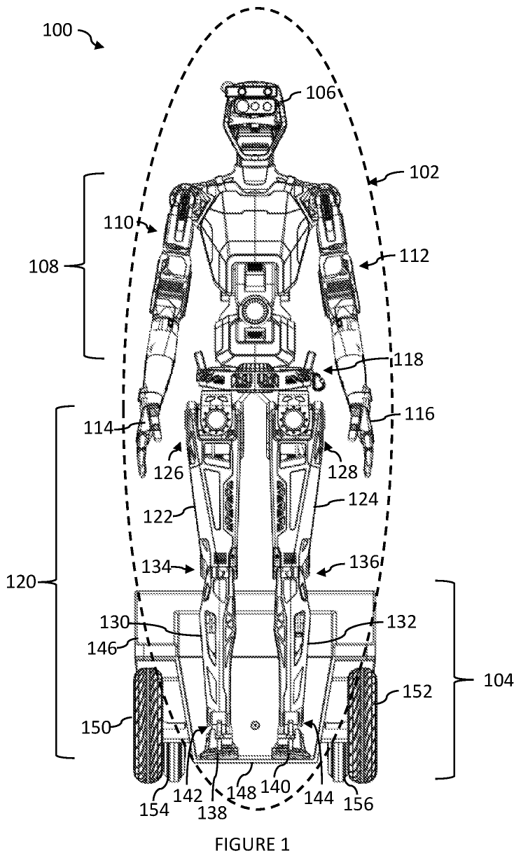

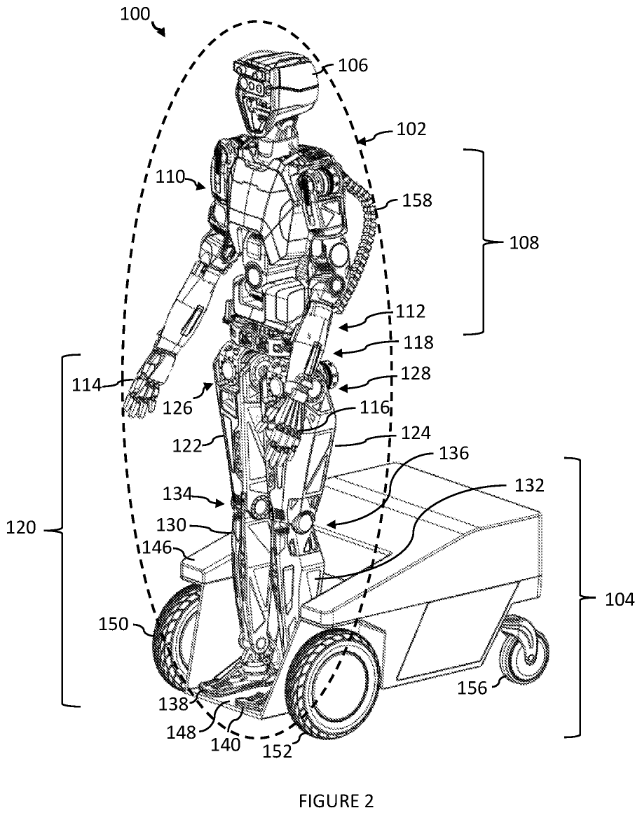

FIG. 1 is a schematic drawing of a front view of an example implementation of a mobile robot system 100, in accordance with the present systems, devices, and methods. Mobile robot system 100 is also shown in FIGS. 2, 3, 4, 5, 6A, and 6B described below. Elements of mobile robot system 100 in FIGS. 1, 2, 3, 4, 5, 6A, and 6B have the same reference numerals as the corresponding elements of mobile robot system 100 in FIG. 1. Mobile robot system 100 of FIGS. 1, 2, 3, 4, 5, 6A, and 6B is described below with reference to FIG. 1.

Mobile robot system 100 includes a robot body 102 and a mobile base 104.

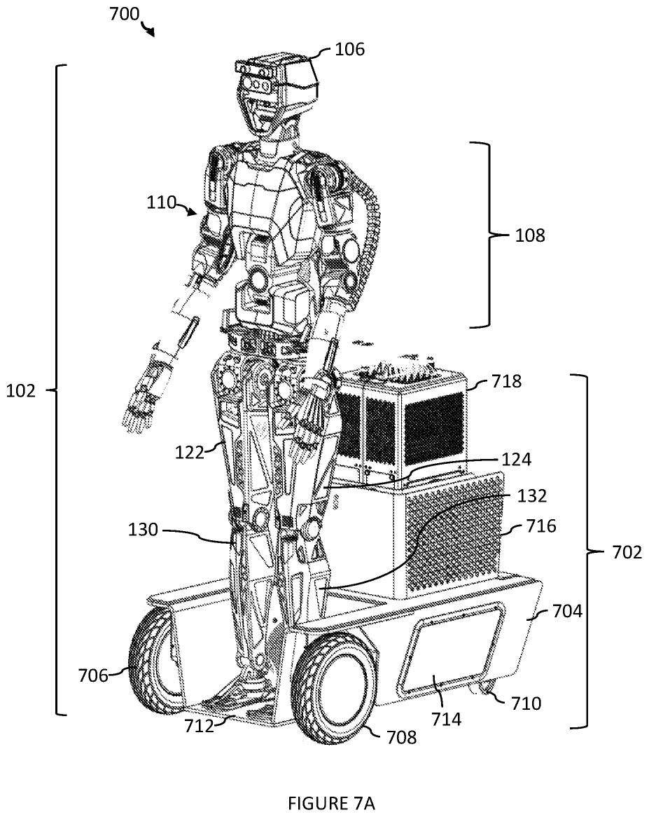

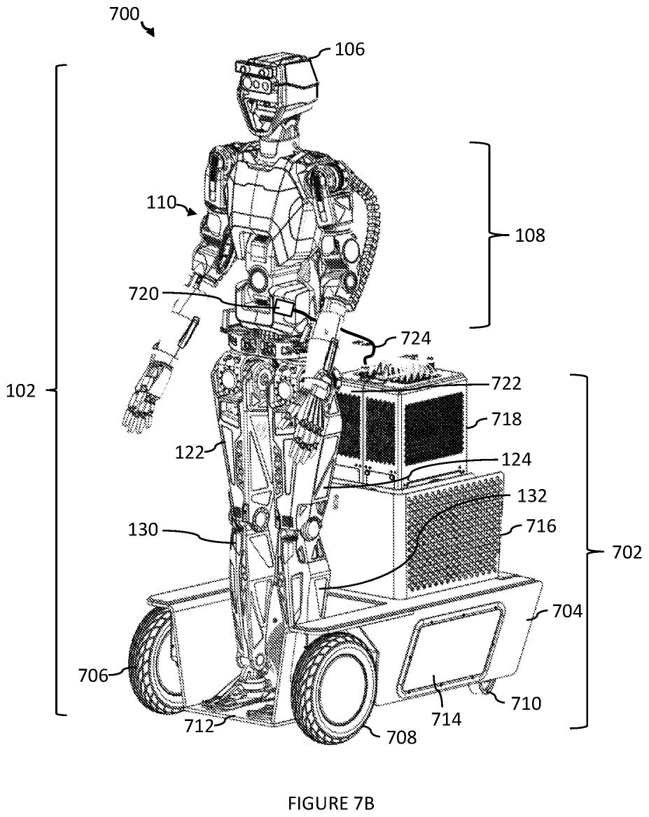

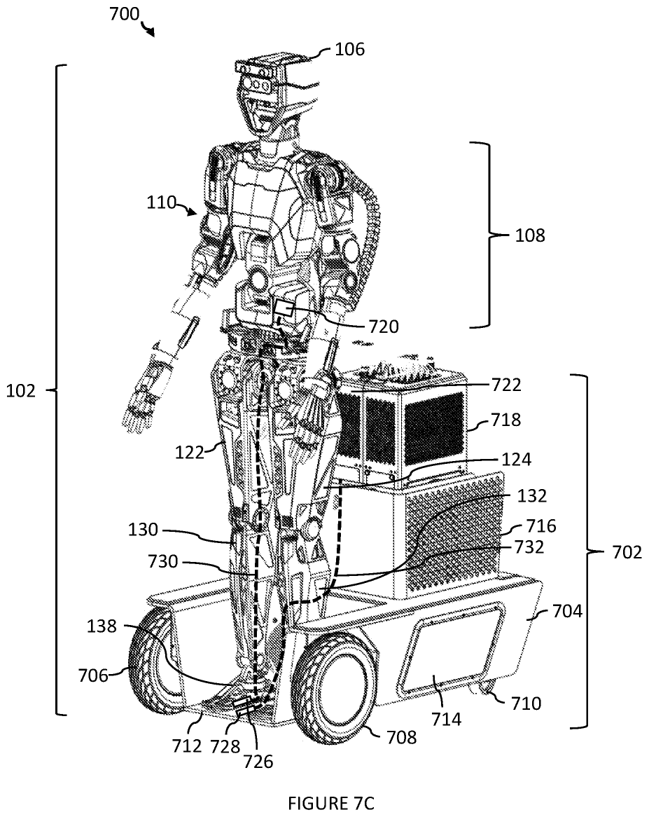

Mobile robot system 100 further includes a head 106, a torso 108, robotic arms 110 and 112, and hands 114 and 116. Robot 100 is a bipedal robot, and includes a joint 118 between torso 108 and robotic legs 120. Joint 118 may allow a rotation of torso 108 with respect to robotic legs 120. Joint 118 may allow torso 108 to bend forward (see, e.g., FIG. 7A).

Robotic legs 120 include upper legs 122 and 124 with hip joints 126 and 128, respectively. Robotic legs 120 also include lower legs 130 and 132, mechanically coupled to upper legs 122 and 124 by knee joints 134 and 136, respectively. Lower legs 130 and 132 are also mechanically coupled to feet 138 and 140 by ankle joints 142 and 144, respectively. In various implementations, one or more of hip joints 126 and 128, knee joints 134 and 136, and ankle joints 142 and 144 are actuatable joints.

Mobile base 104 includes a chassis 146. Chassis 146 includes a platform 148 on which robot body 102 is mounted. Mobile base 104 also includes wheels 150, 152, 154, and 156.

FIG. 2 is a schematic drawing of an isometric view of the mobile robot system of FIG. 1, in accordance with the present systems, devices, and methods. Robot body 102 includes a hydraulic hose 158. In some implementations, mobile robot system 100 includes a hydraulic system to provide power to an end effector of mobile robot system 100 (e.g., to hands 114 and/or 116). Hydraulic hose 158 can provide a hydraulic coupling to components of the hydraulic system. In some implementations, some or all of the hydraulic system (including, e.g., hydraulic hose 158) is adapted and/or miniaturized to fit at least partially inside the robot (e.g., inside torso 108 and/or robotic arms 110 and 112).

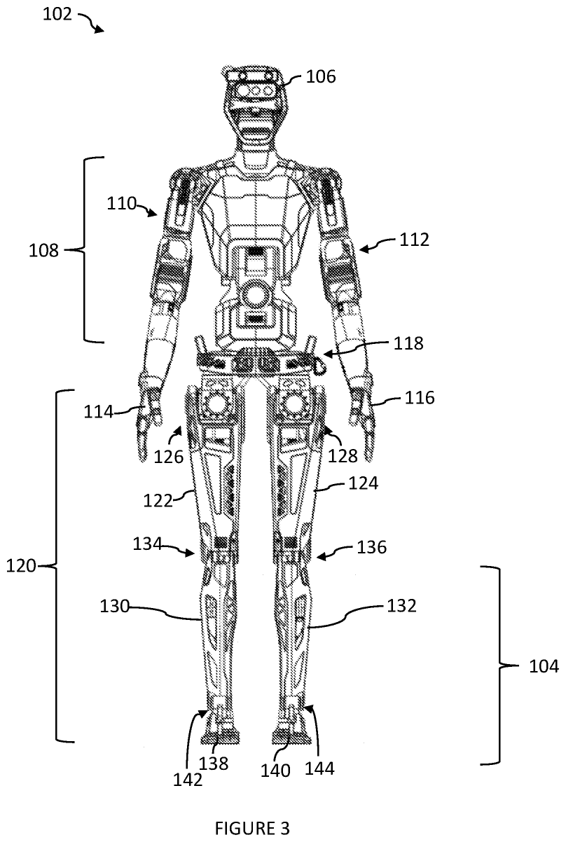

FIG. 3 is a schematic drawing of a front view of robot body 102 of mobile robot system 100 of FIG. 1, in accordance with the present systems, devices, and methods. Robot body 102 may step off platform 148 of mobile base 104. In some implementations, robot body 102 is capable of autonomous travel (e.g., via bipedal walking).

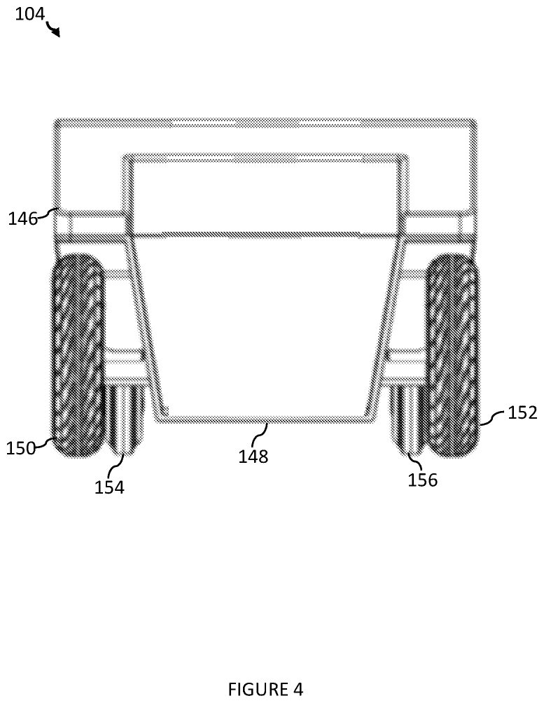

FIG. 4 is a schematic drawing of a front view of mobile base 104 of mobile robot system 100 of FIG. 1, in accordance with the present systems, devices, and methods. Mobile base 104 may travel independently of robot body 102. In some implementations, mobile base 104 is capable of autonomous travel.

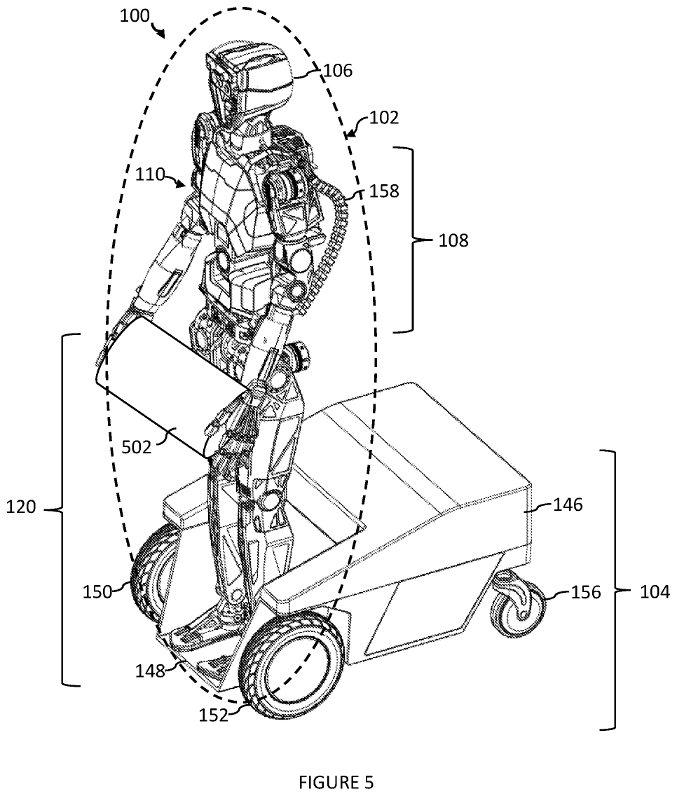

FIG. 5 is a schematic drawing of mobile robot system 100 of FIG. 1 carrying a load 502, in accordance with the present systems, devices, and methods. Load 502 may be an object picked up by robot body 102, for example. Load 502 may be picked up from the ground, or from a shelf, including for example, a shelf low to the ground or a shelf above torso 108 of robot body 102. Load 502 may be an object handed to mobile robot system 200 by a human or another robot.

Robot body 102 is configurable in various articulations, i.e., with joints of robot body 102 at various angles. Robot body 102 is stable in each of the various articulations. In some implementations, mobile base 104 has a weight, shape, and/or measurable extent that ensures mobile robot system 100 is stable, and will not tip over, when robot body 102 is configured in the various articulations, and when each of a load weight, shape, and measurable extent are less than a respective determined threshold value.

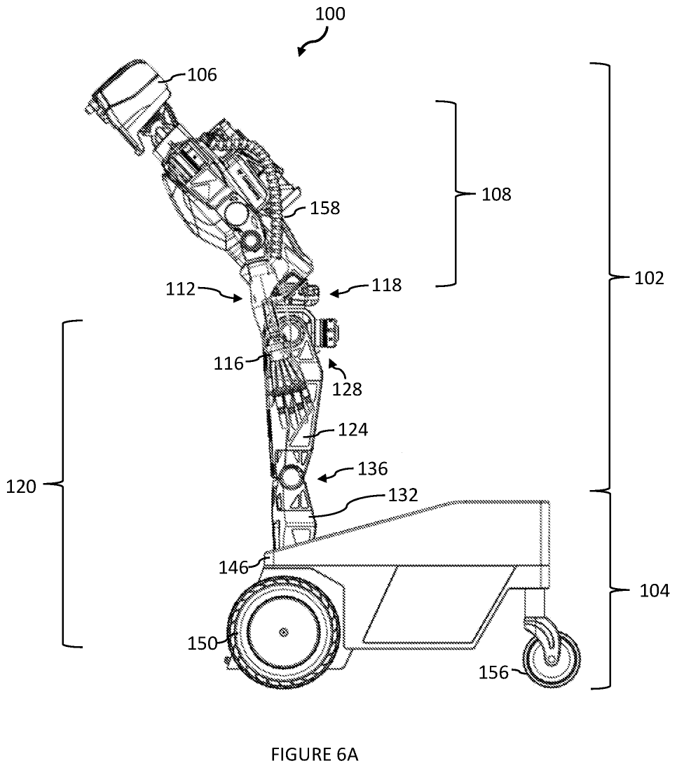

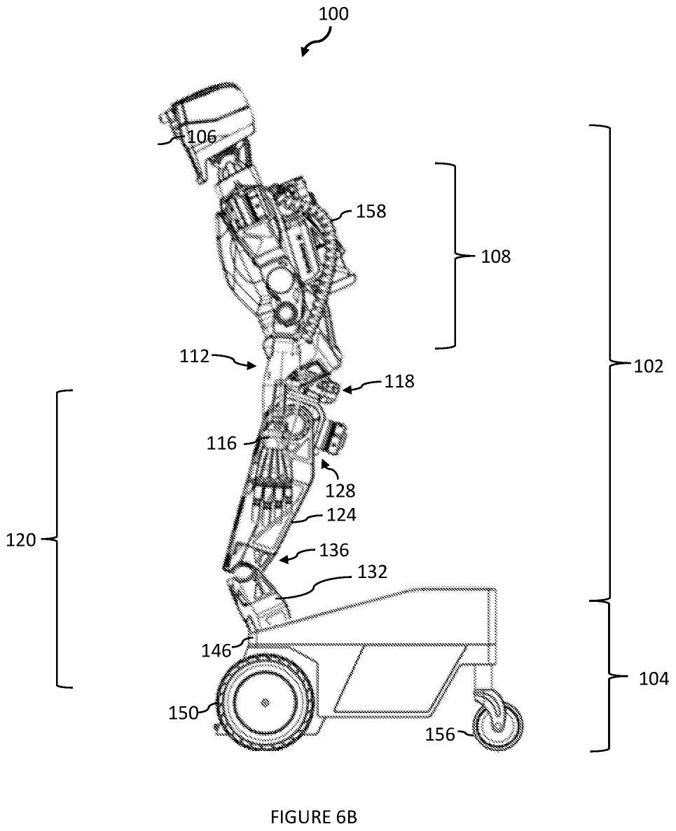

FIG. 6A is a schematic drawing of mobile robot system 100 of FIG. 1 bending forwards, in accordance with the present systems, devices, and methods. As mentioned above with reference to FIG. 5, mobile robot system 100 can be configured in various articulations, i.e., with joints of robot body 102 at various angles. In FIG. 6A, robot body 102 is bending forwards at joint 218. Robot body 102 may bend forwards to pick up an object on the ground, or low to the ground, for example.

FIG. 6B is a schematic drawing of mobile robot system 100 of FIG. 1 bending at knee joints 234 and 236, in accordance with the present systems, devices, and methods. The ability of robot body 102 to have various articulations, including articulations of robotic legs 120, can be advantageous in operation. The various articulations can be configured, for example, using joint 218, hip joints 226 and 228, knee joints 234 and 236, and ankle joints 242 and 244. (Only hip joint 228, and knee joint 236 are visible in FIG. 6B.)

FIG. 7A is a schematic drawing of another example implementation of a mobile robot system 700a, in accordance with the present systems, devices, and methods. Components of robot 700a that are the same as, or similar to, components of mobile robot system 100 of FIG. 1 have the same reference numerals.

Mobile robot system 700a comprises robot body 102 and a mobile base 702. Robot body 102 is described above with reference to FIG. 1. Mobile base 702 comprises a chassis 704, and wheels 706, 708, and 710. Mobile base 702 also comprises a platform 712 on which robot body 102 can be situated. Robot body 102 may step on and off platform 712.

Chassis 704 comprises a hatch 714 which opens to provide access to various components housed in chassis 704.

Mobile base 702 also comprises components 717 and 718 mounted on chassis 704. In some implementations, component 716 includes an electric motor and/or hydraulic or pneumatic components, and component 718 includes a battery and/or compute resources (e.g., computer processors and/or non-transitory processor-readable storage media).

FIG. 7B is a schematic drawing of an example implementation of a mobile robot system 700b having a tethered electrical communicative coupling between the robot body and the mobile base, in accordance with the present systems, devices, and methods. Components of robot 700b that are the same as, or similar to, components of mobile robot system 700a of FIG. 7A, and/or components of mobile robot system 100 of FIG. 1, have the same reference numerals.

Robot 700b includes a primary electrical power source 720. In some implementations, primary electrical power source 720 is a battery. In some implementations, component 718 includes a primary electrical power source 722. In some implementations, primary electrical power source 722 is a battery. Primary electrical power source 720 may be electrically communicatively coupled to primary electrical power source 722 by a tether 724. Tether 724 may include one or more electrical cables.

FIG. 7C is a schematic drawing of an example implementation of a mobile robot system 700c having a wireless electrical communicative coupling between the robot body and the mobile base, in accordance with the present systems, devices, and methods. Components of robot 700c that are the same as, or similar to, components of mobile robot system 700a of FIG. 7A, and/or components of mobile robot system 100 of FIG. 1, have the same reference numerals.

Robot system 700c includes an induction coil 726 located in foot 138 of robot body 102, and an induction coil 728 located in platform 712 of mobile base 702. Induction coils 726 and 728 may be used to provide induction charging of primary electrical power source 720 by primary electrical power source 722. In other implementations, induction coils 726 and 728 are in other locations on robot body 102 and mobile base 702, respectively. Induction coil 726 is electrically communicatively coupled to primary electrical power source 720 by an electrical cable 730. Induction coil 728 is electrically communicatively coupled to primary electrical power source 722 by an electrical cable 732. In FIG. 7C, electrical cables 730 and 732 are shown as dotted lines to indicate that electrical cables 730 and 732 may run through an interior of robot body 102 and mobile base 702, respectively.

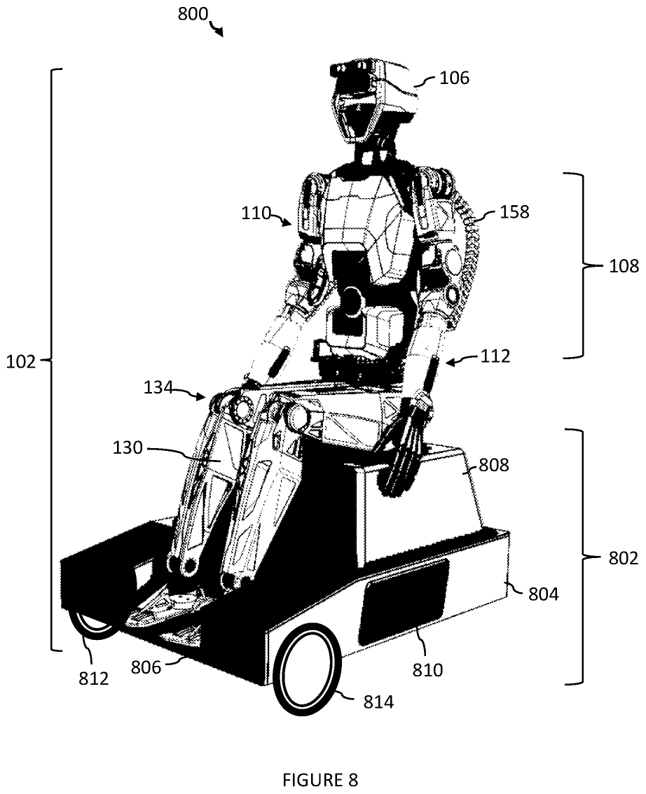

FIG. 8 is a schematic drawing of an example implementation of a mobile robot system 800 with robot body 102 of FIG. 1 in a seated position on mobile base 802, in accordance with the present systems, devices, and methods. Components of robot 800 that are the same as, or similar to, components of mobile robot system 100 of FIG. 1 have the same reference numerals. Robot body 102 is described above with reference to FIG. 1.

Mobile base 802 comprises a chassis 804 and a platform 806. Mobile base 802 also comprises a seat 808 for robot body 102. FIG. 8 shows robot body 102 in a seated position on seat 808.

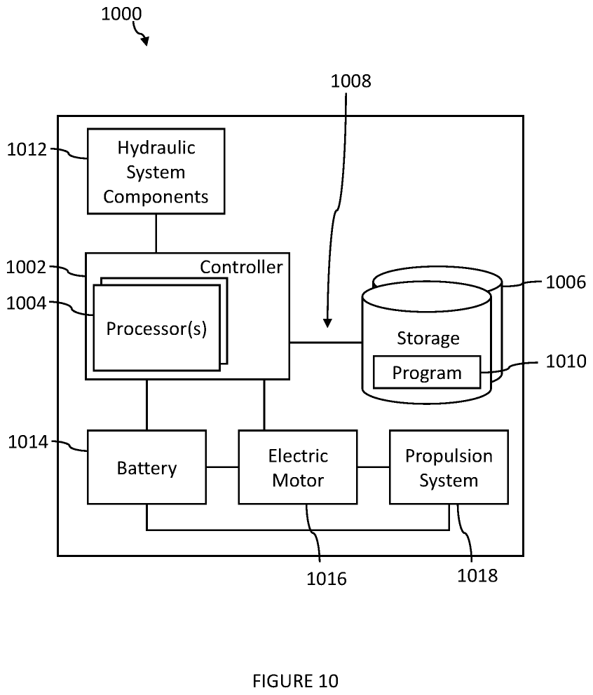

Mobile base 802 also comprises a hatch 810 which can be opened to access various components housed in chassis 804. Components housed in chassis 804 may include a controller, storage media, components of a hydraulic system, a battery, and/or an electric motor. See, for example, the description of FIG. 10 below.

Mobile base 802 also comprises wheels 812 and 814.

Mobile robot system 100 of FIG. 1 may, for example, be a hydraulically-powered robot.

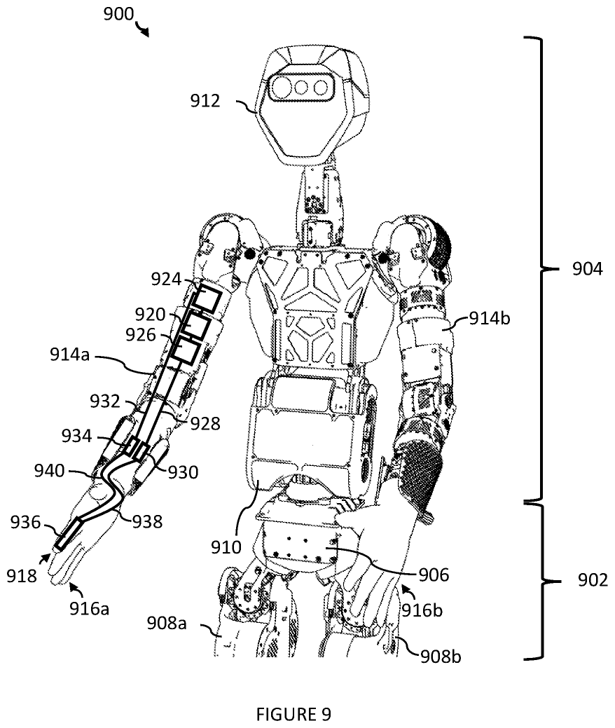

FIG. 9 is a schematic drawing of an example implementation of portion of a hydraulically-powered robot 900, in accordance with the present systems, devices, and methods.

Robot 900 comprises a humanoid lower body 902 and a humanoid upper body 904. Lower body 902 comprises a pelvic region 906 and two legs 908a and 908b (collectively referred to as legs 908). Only the upper portion of legs 908 is shown in FIG. 9. In other example implementations, lower body 902 is a base that may, for example, comprise a stand and (optionally) one or more wheels.

Upper body 904 comprises a torso 910, a head 912, right-side arm 914a and a left-side arm 914b (collectively referred to as arms 914), and a right hand 916a and a left hand 916b (collectively referred to as hands 916). Arms 914 of robot 900 are also referred to in the present application as robotic arms. Arms 914 of robot 900 are humanoid arms. In other implementations, arms 914 have a form factor that is different from a form factor of a humanoid arm.

Hands 916 are also referred to in the present application as end effectors. In other implementations, hands 916 have a form factor that is different from a form factor of a humanoid hand. Each of hands 916 comprises one or more digits, for example, digit 918 of hand 916a. Digits may include fingers, thumbs, or similar structures of the hand or end effector.

Robot 900 is a hydraulically-powered robot. In other implementations, robot 900 has alternative or additional power systems. In some implementations, lower body 902 and/or torso 910 of upper body 904 house a hydraulic control system, for example. In some implementations, components of the hydraulic control system may alternatively be located outside the robot, e.g., on a wheeled unit that rolls with the robot as it moves around (see, for example, base 204 of mobile robot system 100 of FIG. 2), or in a fixed station to which the robot is tethered.

The hydraulic control system of robot 900 comprises a hydraulic pump 922, a reservoir 924, and an accumulator 926, housed in arm 914a. Hose 928 provides a hydraulic coupling between accumulator 926 and a pressure valve 930 of the hydraulic control system. Hose 932 provides a hydraulic coupling between an exhaust valve 934 of the hydraulic control system and reservoir 924.

Pressure valve 930 is hydraulically coupled to an actuation piston 936 by a hose 938. Actuation piston 936 is hydraulically coupled to exhaust valve 934 by a hose 940. Hoses 928 and 938, and pressure valve 930, provide a forward path to actuation piston 936. Hoses 932 and 940, and exhaust valve 934 provide a return path to actuation piston 936. Pressure valve 930 and exhaust valve 934 can control actuation piston 936, and can cause actuation piston 936 to move, which can cause a corresponding motion of at least a portion of hand 916a, for example, digit 918.

Each of hands 916 may have more than one degree of freedom (DOF). In some implementations, each hand has up to eighteen (18) DOFs. Each DOF can be driven by a respective actuation piston (for example, actuation piston 936). For clarity of illustration, only one actuation piston is shown in FIG. 9. Each actuation piston may be located in hands 916.

In some implementations, digit 918 may include multiple actuators. Some actuators may be used to control movement of joints in digit 918. For example, actuators may be used to control movement of one or more knuckle joints.

Digit 918 may include one or more knuckle joints. For example, digit 918 may include one or more of a metacarpophalangeal (MCP) joint, a proximal interphalangeal (PIP) joint, and a distal interphalangeal (DIP) joint. Digit 918 may include a spherical differential joint (e.g., a spherical differential MCP joint) as described above (for example, the joint of portion 100c of FIG. 1C). The spherical differential joint of digit 918 may be hydraulically-actuated.

Digit 918 may include one or more position transducers operable to provide positional data for robot 900 to be self-aware of a position of one or more components of digit 918 with respect to each other, and/or to provide control of digit 918.

FIG. 10 is a block diagram of an example implementation of a system 1000 of components housed in a base of a robot (for example, mobile robot system 100 of FIG. 1, robot 600 of FIG. 6, or robot 700 of FIG. 7), in accordance with the present systems, devices, and methods.

System 1000 comprises a controller 1002. Controller 1002 comprises at least one processor 1004. Processor 1004 may be any logic processing unit, including for example, one or more central processing units (“CPUs”), digital signal processors (“DSPs”), and/or application-specific integrated circuits (“ASICs”).

System 1000 further comprises at least one non-transitory processor-readable storage medium 1006 communicatively coupled to processor 1004 by a bus 1008. Storage medium 1006 can store instructions and/or data that can be executed by processor 1004. Storage medium 1006 can store a computer program product 1010 comprising data and processor-executable instructions. The computer program product can cause processor 1004 to provide commands to controller 1002 to cause the robot to perform an action and/or a maneuver (e.g., a change in the robot's position and/or orientation in the robot's environment). Storage medium 1006 may be any suitable non-volatile storage medium, including for example, a hard disk drive for reading from and writing to a hard disk, a solid-state drive, an optical disk drive for reading from and writing to removable optical disks, and/or a magnetic disk drive for reading from and writing to magnetic disks.

System 1000 further comprises one or more components 1012 of a hydraulic system, a battery 1014, and an electric motor 1016. Battery 1014 may provide power to components of a robot body to which it is electrically communicatively coupled. Battery 1014 may provide power to electric motor 1016. Electric motor 1016 may drive components of the robot body to which it is communicatively coupled.

System 1000 further comprises a propulsion system 1018 which is operable to cause a motion of the mobile base. Motion of the mobile base can cause a change in at least one of a position or an orientation of the robot in the robot's environment. The propulsion system may draw power from battery 1014 and may include electric motor 1016.

The technology described in the present application includes systems, devices, and methods for autonomous or semi-autonomous swapping of electrical power sources (e.g., batteries) between a robot body and a repository of compatible electrical power sources on a mobile base. When an electrical power source of a robot body is in a low-power condition, the technology provides for autonomous or semi-autonomous replacement, recharging, and/or replenishment of the electrical power source, so that the robot body can perform its task with little or no interruption to the task, and with little or no human intervention.

A mobile robot system typically includes at least one power source, for example, an electrical power source on each of the robot body and the mobile base. A mobile robot system may include multiple robot bodies and/or multiple mobile bases. In some implementations, mobile bases are interchangeable, i.e., at least one of the robot bodies is able to interact with more than one of the mobile bases.

A hydraulic robot may include motors, pumps, sensors, controllers, and/or processor that are powered by an electrical power source. Some robots can be tethered to a source of electrical power without affecting their functionality. Other robots are untethered and have an on-board source of electrical power, for example a battery, a fuel cell, or a supercapacitor.

Some on-board sources of electrical power rely on a charge or a fuel which is depleted over time, and consequently have a need for periodic recharging, replenishment, and/or replacement.

An advantage of using a general-purpose robot to perform a task is that the robot can typically work longer hours than a human performing the same task. In some situations, the robot can perform a task without taking a break, i.e., 24/7. It can therefore be desirable for the robotic system to be operable to recharge, replenish, and/or replace a power source of the robot without causing a significant interruption to the robot's task, i.e., without causing the robot to be idle while the power source is recharged, replenished, and/or replaced.

An advantage of an autonomous robot is that it can operate with little or no human oversight, or intervention, during performance of the robot's task. It can be desirable for the robot to be similarly autonomous during recharging, replenishment, and/or replacement of an electrical power source.

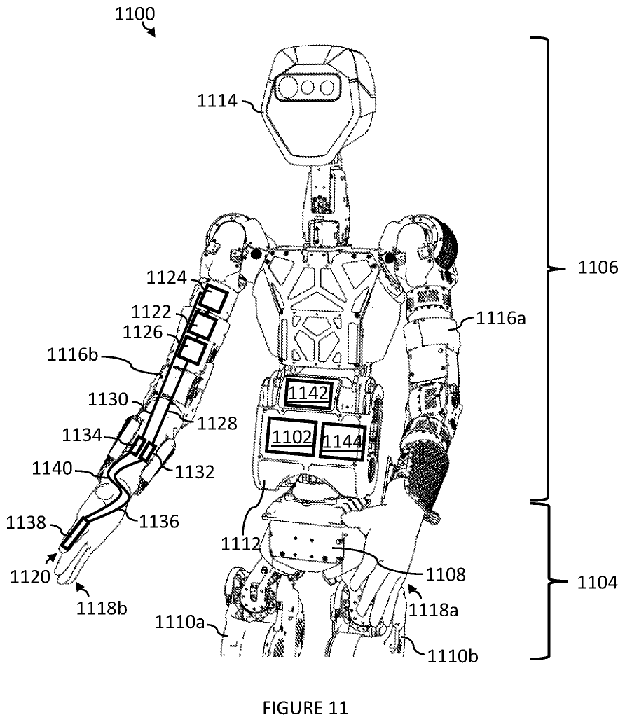

FIG. 11 is a schematic diagram of an example implementation of a robot 1100 with an electrical power source 1102, in accordance with the present systems, devices, and methods. Robot 100 may be autonomous or semi-autonomous. Robot 1100 may be a general-purpose robot. Electrical power source 1102 may be at least one of a battery, a fuel cell, or a supercapacitor.

Robot 1100 comprises a base 1104 and a humanoid robot body 1106. Base 1104 comprises a pelvic region 1108 and two legs 1110a and 1110b (collectively referred to as legs 1110). Only the upper portion of legs 1110 is shown in FIG. 11. In other example implementations, base 1104 may comprise a stand and (optionally) one or more wheels.

Robot body 1106 comprises a torso 1112, a head 1114, a left-side arm 1116a and a right-side arm 1116b (collectively referred to as arms 1116), and a left hand 1118a and a right hand 1118b (collectively referred to as hands 1118). Arms 1116 of robot 1100 are also referred to in the present application as robotic arms. Arms 1116 of robot 1100 are humanoid arms. In other implementations, arms 1116 have a form factor that is different from a form factor of a humanoid arm.

Hands 1118 are also referred to in the present application as end effectors. In other implementations, hands 1118 have a form factor that is different from a form factor of a humanoid hand. Each of hands 1118 comprises one or more digits, for example, digit 1120 of hand 1118b. Digits may include fingers, thumbs, or similar structures of the hand or end effector.

In some implementations, robot 1100 is a hydraulically-powered robot. Components of a hydraulic control system may be housed, for example, in base 1104 and/or torso 1112 of robot body 1106. Components of the hydraulic control system may also be located outside the robot, e.g., on a wheeled unit that rolls with the robot as it moves around, or in a fixed station to which the robot is tethered. Components of the hydraulic control system in base 1104 may be detachable hydraulically coupled to robot body 1106.

In the implementation of FIG. 11, robot 1100 includes a hydraulic pump 1122, a reservoir 1124, and an accumulator 1126 integrated with arm 1116b of robot 1100.

Robot 1100 further comprises hoses 1128 and 1130. Hose 1128 provides a hydraulic coupling between accumulator 1126 and a pressure valve 1132. Hose 1130 provides a hydraulic coupling between an exhaust valve 1134 and reservoir 1124. Robot 1100 further comprises hose 1136 which runs from pressure valve 1132 to actuation piston 1138, and hose 1140 which runs to exhaust valve 1134 from actuation piston 1138. Hoses 1128 and 1136, and pressure valve 1132, provide a forward path to actuation piston 1138. Hoses 1130 and 1140, and exhaust valve 1134 provide a return path from actuation piston 1138. The hydraulic fluid in the hydraulic hoses of FIG. 11 (including hoses 1128 and 1130) can be an oil, for example, peanut oil or mineral oil.

Pressure valve 1132 and exhaust valve 1134 can control actuation piston 1138, and can cause actuation piston 1138 to move, which can cause a corresponding motion of at least a portion of hand 1118b, for example, digit 1120.

In some implementations, pressure valve 1132 and exhaust valve 1134 are electrohydraulic servo valves controlled by a controller 1142. The electrohydraulic servo valves are also referred to in the present application as servo valves and servo-controlled valves. Controller 1142 may be implemented by any suitable combination of hardware, software, and/or firmware. Controller 1142 may include, for example one or more application-specific integrated circuit(s), standard integrated circuit(s), and/or computer program(s) executed by any number of computers, microcontrollers, and/or processors (including, e.g., microprocessors, central processing units). In other implementations, other suitable types of valves may be used.

Pump 1122, pressure valve 1132, and exhaust valve 1134 are examples of components of the hydraulic control system of robot 1100 that can be powered by electrical power source 1102. Controller 1142 is an example of an electronic system that can also be powered by electrical power source 1102.

In other implementations, the hydraulic drive mechanism includes a motor and a drive piston. The motor and the drive piston are further examples of components of robot 1100 that can be powered by electrical power source 1102. In other implementations, robot 1100 is an electromechanical robot. In yet other implementations, robot 1100 is a cable-driven robot.

Electrical power source 1102 may be a primary electrical power source. A primary electrical power source is an electrical power source used by robot 1100 in normal operation to power electrical and/or electronic components of robot 1100 (for example, pump 1122 and controller 1142).

FIG. 11 shows a single primary electrical power source 1102. Those of skill in the art will appreciate that robot 1100 may include more than one primary electrical power source. In some implementations, each primary electrical power source is dedicated to a respective designated subset of electrical or electronic components on robot 1100. In some implementations, multiple primary power sources may be included to provide redundancy in the event of a failure of one primary power source.

Robot 1100 also includes a secondary power source 1144. A secondary power source of robot 1100 (for example, secondary power source 1144) is an electrical power source that can be engaged by robot 1100 (or by another element of a robotic system of which robot 1100 is a part) to maintain electrical power to electrical and/or electronic components of robot 1100 when a primary electrical power source (for example electrical power source 1102) is unavailable. The primary electrical power source may be unavailable, for example, when the present electrical power source is being swapped for a replacement primary electrical power source. The secondary power source may have a lower capacity than the primary power source. Secondary power source 1144 may be a secondary battery, for example.

In some implementations, a robot with an integrated hydraulic system, such as robot 1100 of FIG. 11, may employ any or all of the teachings of U.S. Provisional Patent Application Ser. No. 63/191,732, filed May 21, 2021 and entitled “Systems, Devices, and Methods for A Hydraulic Robot Arm”, which is incorporated herein by reference in its entirety.

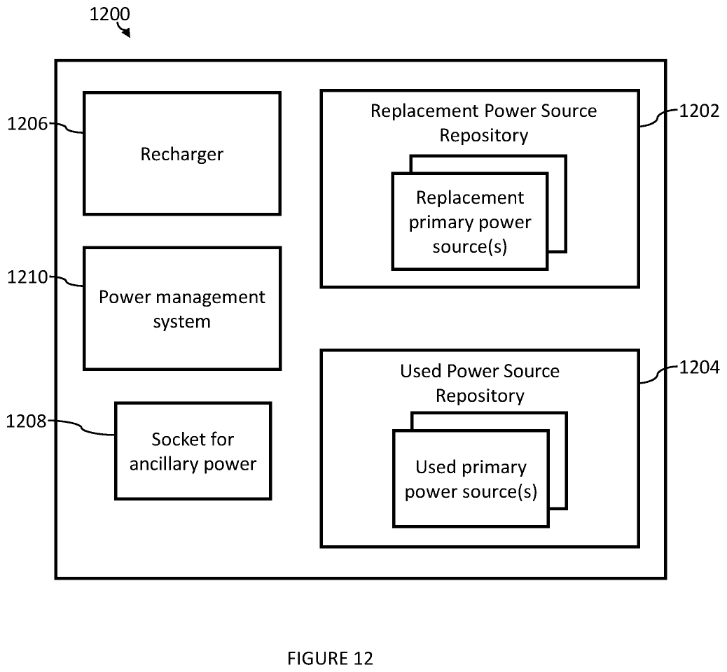

FIG. 12 is a block diagram of an example implementation of a power source exchange station 1200, in accordance with the present systems, devices, and methods.

Power source exchange station 1200 includes a replacement power source repository 1202 which includes one or more replacement primary electrical power sources compatible with at least one robot (e.g., mobile robot 100 of FIG. 1). Power source exchange station 1200 also includes a used power source repository 1204 which includes one or more used, depleted, or discharged primary electrical power sources received from at least one robot (e.g., robot 100 of FIG. 1).

Power source exchange station 1200 may include a recharger. The recharger may be suitable for recharging a primary electrical power source (e.g., a battery) from a robot. Recharging may be performed, for example, via a cabled or tethered electrical communicative coupling, or wirelessly by induction.

Power source exchange station 1200 may include a socket 1208 for ancillary electrical power. Socket 1208 may provide DC power. Socket 1208 may be used to provide secondary power to a robot while the robot is exchanging a primary power source with power source exchange station 1200. Socket 1208 may be used to provide secondary power to a robot while the robot is recharging (or otherwise waiting for) a primary power source.

Power source exchange station 1200 may include a power management system 1210. Power management system 1210 may include at least one processor. In some implementations (for example, when the robot is unable to identify for itself a condition of the robot's primary power source), power management system 1210 may be used to identify a low-power condition in a robot. Power management system 1210 may be used to provide an automated exchange of primary power source with a robot, including engaging and disengaging a source of secondary power to maintain power to the robot during the exchange.

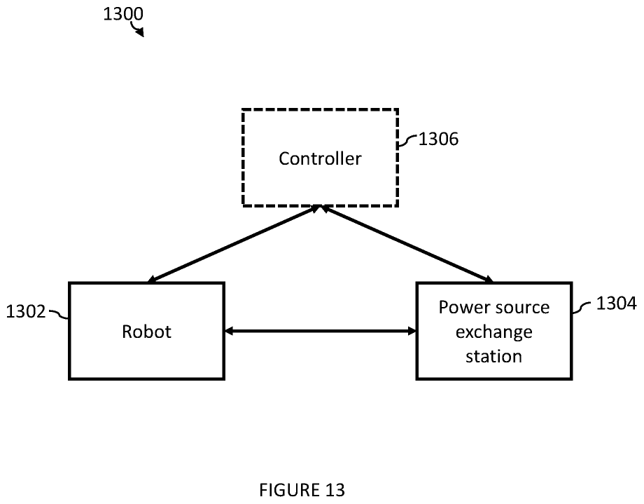

FIG. 13 is a block diagram of an example implementation of a robotic system 1300 with a robot 1302 and a power source exchange station 1304.

Robot 1302 may be a general-purpose robot. Robot 1302 may be an autonomous or semi-autonomous robot. Robot 1302 has a primary electrical power source. The primary electrical power source may be on-board robot 1302. The primary electrical power source may be a battery, fuel cell, or supercapacitor, for example. The primary electrical power source may power one or more electrical or electronic components on-board the robot.

Power source exchange station 1304 may be a mobile or a fixed station. Power source exchange station 1304 may include a repository of one or more replacement primary electrical power sources that are compatible with robot 1302 and interchangeable with the primary electrical power source of robot 1302. Power source exchange station 1304 may include a recharger. Power source exchange station 1304 may include a source of fuel, for example, hydrogen or methanol for a fuel cell. Power source exchange station 1304 may install a replacement fuel tank on robot 1302, or may add fuel to a fuel tank already installed on robot 1302.

Robotic system 1300 may exchange a primary electrical power source on-board robot 1302 for a replacement primary electrical power source in the repository of power source exchange station 1304. Robotic system 1300 may initiate this exchange when a low-power condition in the primary electrical power source on-board robot 1302 is identified.

Robotic system 1300 optionally includes a standalone controller 1306 (indicated by dotted lines in FIG. 13). Controller 1306 may identify a low-power condition of a primary electrical power source and/or cause an exchange of the primary electrical power source of robot 1302 for a replacement primary electrical power source at power source exchange station 1304.

In some implementations, the technology described in the present application automatically swaps a discharged battery in the robot for a new or recharged battery at a battery-swapping station.

When the robot identifies a low-battery condition, it proceeds to the battery-swapping station. A low-battery condition may be identified by a battery management system on-board the robot, for example. A low-battery condition may be identified, for example, by monitoring a remaining capacity of the battery. In some implementations, a battery system may perform a capacity test to determine whether the battery can support a desired current for a given length of time. In other implementations, a low-battery condition is identified by monitoring an internal resistance of one or more cells in the battery. In some implementations, a low-battery condition is inferred by analyzing a trend in a performance metric of the battery. In some implementations, the robotic system anticipates the low-battery condition, and initiates an exchange before the low-battery condition is reached. While the above text refers to a low-battery condition, it will be appreciated by those of skill in the art that an equivalent condition can be identified and acted upon for other electrical power sources (e.g., fuel cells and supercapacitors).

In some implementations, battery-swapping by the robot and the battery-swapping station is performed autonomously, i.e., with little or no human intervention. In some implementations, a secondary power source is engaged to provide power to the robot while the battery is being swapped and power from either the battery being replaced or the replacement battery is temporarily unavailable. The secondary power source may be a secondary battery on-board the robot, for example. It may be sufficient for the secondary battery to provide about five (5) minutes of power. In some implementations, the secondary battery can be recharged by the primary battery.

The secondary power source may be a DC supply via an electrical coupling between the battery-swapping station and the robot. In some implementations, the robot includes a socket on-board the robot to receive a tethered connection to a source of electrical power located at the battery swapping station.

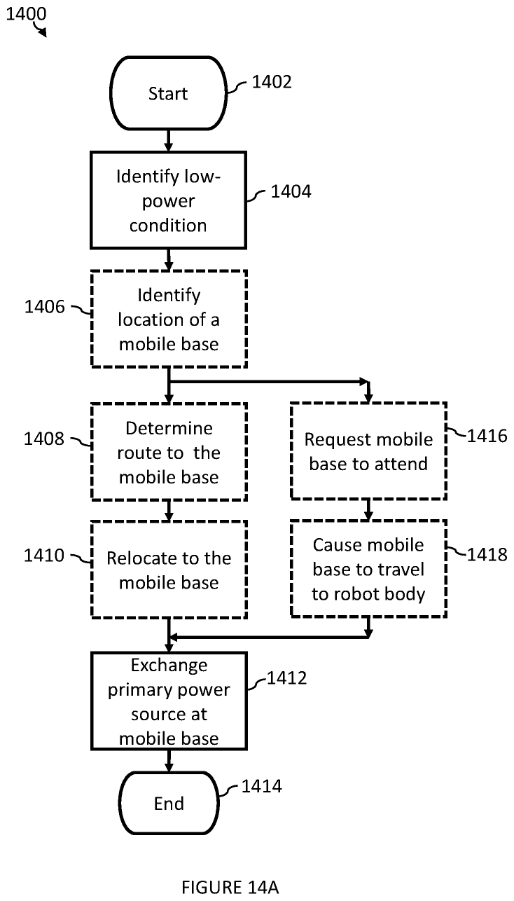

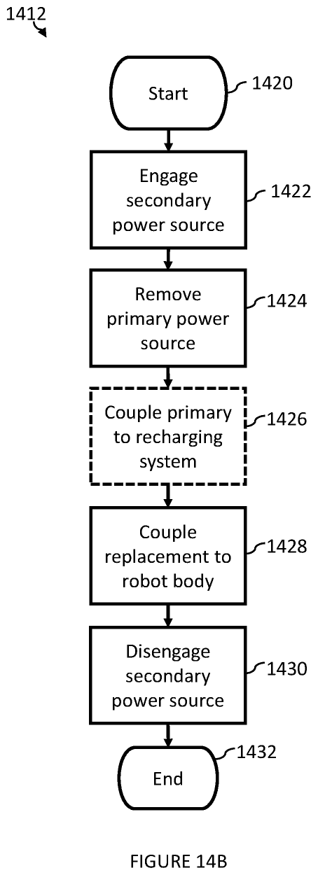

FIG. 14A is a flow chart of an example method of operation 1400 of a mobile robot system, in accordance with the present systems, devices, and methods. Method 1400 of FIG. 14A includes nine (9) acts 1402, 1404, 1406, 1408, 1410, 1412, 1414, 1416, and 1418. Those of skill in the art will appreciate that in alternative implementations certain acts of FIG. 14A may be omitted and/or additional acts may be added. Those of skill in the art will also appreciate that the illustrated order of the acts is shown for exemplary purposes only and may change in alternative implementations.

At 1402, in response to a starting condition (e.g., a controller powering up), the method starts. The mobile robot system includes a robot body and a mobile base, as described above with reference to FIGS. 1, 2, 3, and 4, for example. The mobile base includes a power source exchange station.

At 1404, the mobile robot system identifies a low-power condition. In some implementations, the robot body identifies the low-power condition. In other implementations, the mobile base identifies the low-power condition. In yet other implementations, the low-power condition is identified by a controller separate to both the robot body and the mobile base.

The low-power condition indicates the robot body needs to replace, recharge, or replenish its primary electrical power source. The low-power condition may be identified, for example, by monitoring an internal condition of the power source, as described above for the example of a battery.

Acts 1406, 1408, and 1410 are optional, as indicated by the dotted lines. At 1406, the mobile robot system identifies a location of the mobile base. If there are multiple mobile bases, the mobile base identified at 1406 may be the one closest to a current location of the robot body, for example. At 1408, the robotic system determines at least one route from the robot body's current location to the location of the mobile base. At 1410, the mobile robot system causes the robot body to re-locate to the location of the mobile base via one of the determined routes. In some implementations, acts 1406, 1408, and 1410 are performed by at least one processor on-board the robot.

At 1412, the mobile robot system exchanges a primary electrical power source on-board the robot body for a replacement, recharged, or replenished electrical power source from the power source exchange station at the mobile base. At 1414, method 1400 ends, for example, when the robot leaves the mobile base and returns to its task.

As shown in FIG. 14A, at 1416, in some implementations, the mobile robot system requests the mobile base with the power source exchange station to attend, i.e., to travel to the location of the robot body. At 1418, the mobile robot system causes the mobile base to travel to the robot.

In some implementations, the mobile robot system installs an additional power source on-board the robot. This may be instead of, or in addition to, replacing a power source that has a low-power condition.

In some implementations, the robot body is tethered to a primary electrical power source. For example, the robot body may be mobile, and the power source may be fixed, e.g., on the mobile base.

FIG. 14B is a flow chart of an example method of implementation of act 1412 of FIG. 14A for exchanging a primary power source of a robot at a power source exchange station, in accordance with the present systems, devices, and methods. Method 1412 of FIG. 14B includes seven (7) acts 1420, 1422, 1424, 1426, 1428, 1430, and 1432. Those of skill in the art will appreciate that in alternative implementations certain acts of FIG. 14B may be omitted and/or additional acts may be added. Those of skill in the art will also appreciate that the illustrated order of the acts is shown for exemplary purposes only and may change in alternative implementations.

The power source exchange station may be a mobile base of a mobile robot system comprising a robot body and the mobile base.

At 1420, in response to a starting condition (e.g., the robot body arriving at the power source exchange station), the method starts. At 1422, the mobile robot system engages a temporary secondary power source for the robot body. In some implementations, the robot body switches to a secondary battery on-board the robot body. In other implementations, the robot body electrically couples to a power supply provided by the power source exchange station, for example, a DC supply from an AC/DC converter that is electrically coupled to a mains supply at the power source exchange station.

At 1424, the mobile robot system removes the robot body's primary power source. In some implementations, the robot body removes its primary battery.

Optionally (as indicated by the dotted lines), at 1426, the mobile robot system electrically couples the robot body's removed primary power source to a recharging or replenishment system, and commences recharging/replenishing. For example, if the robot body's primary power source is a battery, then the mobile robot system may electrically couple the battery to a battery charger, and initiate a recharging cycle.

At 1428, the mobile robot system electrically couples a replacement primary power source to the robot body. The replacement primary power source may, for example, be a fully-charged battery compatible with the robot body. At 1430, the mobile robot system disengages the secondary power source. At 1432, the method ends, for example, when the robot body leaves the power source exchange station and returns to its task.

In some implementations, the robot body is a humanoid robot having one or more hands, and able to move on legs and/or wheels. In some implementations, the robot body performs the acts described with reference to FIG. 14B. These may include, for example, disconnecting and removing the primary power source, delivering it to the power source exchange station, identifying a compatible replacement primary power source at the power source exchange station, and installing the replacement primary power source in the robot body. The primary power source may be a battery, and the replacement may be a new or fully-charged battery.

In some implementations, at least one element of the mobile robot system is autonomous or semi-autonomous. In some implementations, the mobile robot system is a general purpose robot, and swapping the robot body's primary electrical power source is one of the robot body's functions. In some implementations, where the robot body is an autonomous or semi-autonomous humanoid robot, the robot body includes one or more hands (i.e., humanoid end effectors, for example, hands 118 of robot 100 of FIG. 1), and the robot body can use its hands to perform acts described above with reference to FIG. 14B. The robot body may, for example, use its hands to disconnect and remove the primary power source, deliver it to the power source exchange station, select a replacement, and/or install and connect the replacement.

In some implementations, the power source exchange station is automated, and able to perform at least some of the acts described with reference to FIG. 14B. These may include, for example, disconnecting and removing the primary power source from the robot body, and installing a replacement primary power source in the robot.

In some implementations, the robot body and the power source exchange station in the mobile base are both able to perform at least some of the acts described with reference to FIG. 14B. For example, the robot body may disconnect the primary power source, and the power source exchange station may remove and replace it by a replacement power source, before the robot body completes the reconnection of the replacement power source.

In some implementations, the mobile base can be directed by a controller to a robot body that has a present or impending low-power condition, and/or can be summoned by the robot body.

The robot systems, methods, control modules, and computer program products described herein may, in some implementations, employ any of the teachings of U.S. patent application Ser. No. 16/940,566 (Publication No. US 2021-0031383 A1), U.S. patent application Ser. No. 17/023,929 (Publication No. US 2021-0090201 A1), U.S. patent application Ser. No. 17/061,187 (Publication No. US 2021-0122035 A1), U.S. patent application Ser. No. 17/098,716 (Publication No. US 2021-0146553 A1), U.S. patent application Ser. No. 17/111,789 (Publication No. US 2021-0170607 A1), U.S. patent application Ser. No. 17/158,244 (Publication No. US 2021-0234997 A1), U.S. Provisional Patent Application Ser. No. 63/001,755 (Publication No. US 2021-0307170 A1), and/or U.S. Provisional Patent Application Ser. No. 63/057,461, as well as U.S. Provisional Patent Application Ser. No. 63/151,044, U.S. Provisional Patent Application Ser. No. 63/173,670, U.S. Provisional Patent Application Ser. No. 63/184,268, U.S. Provisional Patent Application Ser. No. 63/213,385, U.S. Provisional Patent Application Ser. No. 63/232,694, U.S. Provisional Patent Application Ser. No. 63/253,591, U.S. Provisional Patent Application Ser. No. 63/293,968, U.S. Provisional Patent Application Ser. No. 63/293,973, U.S. Provisional Patent Application Ser. No. 63/278,817, and/or U.S. patent application Ser. No. 17/566,589, each of which is incorporated herein by reference in its entirety.

Throughout this specification and the appended claims, infinitive verb forms are often used. Examples include, without limitation: “to provide,” “to control,” and the like. Unless the specific context requires otherwise, such infinitive verb forms are used in an open, inclusive sense, that is as “to, at least, provide,” “to, at least, control,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of robotic systems and hydraulic circuits provided.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A mobile robot system comprising:
a robot body, the robot body comprising:
a torso;
a first robotic arm mechanically coupled to the torso;
a first robotic leg; and
a second robotic leg, wherein the first robotic leg and the second robotic leg are controllably actuatable to enable the robot body to execute bipedal walking; and
a mobile base comprising:
a platform to receive a lower end of the first robotic leg and a lower end of the second robotic leg;
at least one wheel and a controllable steering mechanism to enable the mobile base to travel both while the robot body is positioned on the platform and while the robot body is not positioned on the platform; and
a plurality of components, at least one component of the plurality of components operable to support at least one function of the robot body.

2. The mobile robot system of claim 1, wherein the robot body is capable of autonomous travel.

3. The mobile robot system of claim 1, further comprising a hydraulic system, wherein at least one component of the hydraulic system is housed in the robot body.

4. The mobile robot system of claim 3, wherein the hydraulic system is operable to cause a motion of at least one of the first robotic leg, the second robotic leg, and the first robotic arm.

5. The mobile robot system of claim 3, wherein at least one of the plurality of components of the mobile base is a component of the hydraulic system, the component of the hydraulic system hydraulically coupleable to the robot body.

6. The mobile robot system of claim 1, further comprising a controller operable to control an action of the robot body.

7. The mobile robot system of claim 6, wherein at least one of the plurality of components of the mobile base is the controller, the controller communicatively coupled to the robot body.

8. The mobile robot system of claim 1, wherein at least one of the plurality of components of the mobile base is a first primary electrical power source operable to provide electrical power to the mobile base.

9. The mobile robot system of claim 8, the robot body further comprising:
a second primary electrical power source operable to provide electrical power to the robot body;
a controller comprising at least one processor; and
at least one non-transitory processor-readable storage medium communicatively coupled to the at least one processor, the at least one non-transitory processor-readable storage medium storing processor-executable instructions and/or data that, when executed by the at least one processor, cause the robot body to:
identify a low-power condition of the second primary electrical power source of the robot body; and
in response to identifying the low-power condition, establish an electrical communicative coupling between the first primary electrical power source of the mobile base and the second primary electrical power source of the robot body to recharge the second primary electrical power source of the robot body using the first electrical power source of the mobile base.

10. The mobile robot system of claim 9, wherein the electrical communicative coupling between the first primary electrical power source of the mobile base and the second primary electrical power source of the robot body is a tethered electrical communicative coupling between the mobile base and the robot body.

11. The mobile robot system of claim 10, wherein the tethered electrical communicative coupling between the mobile base and the robot body includes an electrical cable.

12. The mobile robot system of claim 9, wherein the electrical communicative coupling between the first primary electrical power source of the mobile base and the second primary electrical power source of the robot body is a wireless electrical communicative coupling between the mobile base and the robot body.

13. The mobile robot system of claim 12, wherein the wireless electrical communicative coupling between the mobile base and the robot body is an inductive coupling.

14. The mobile robot system of claim 8, wherein the mobile base further includes a secondary electrical power source, and wherein the robot body further comprises:
a second primary electrical power source operable to provide electrical power to the robot body;
a controller comprising at least one processor; and
at least one non-transitory processor-readable storage medium storing processor-executable instructions and/or data that, when executed by the at least one processor, cause the robot body to:
identify a low-power condition of the second primary electrical power source of the robot body; and
in response to identifying the low-power condition, exchange the second primary electrical power source of the robot body for the secondary power source of the mobile base.

15. The mobile robot system of claim 14, wherein the processor-executable instructions and/or data that, when executed by the at least one processor, cause the robot body to exchange the second primary electrical power source of the robot body for the secondary power source of the mobile base, cause the robot body to walk to the mobile base.

16. The mobile robot system of claim 14, wherein the processor-executable instructions and/or data that, when executed by the at least one processor, cause the robot body to exchange the second primary electrical power source of the robot body for the secondary power source of the mobile base, cause the mobile base to travel to the robot body.

17. The mobile robot system of claim 1, wherein the mobile robot system further comprises a controller, the controller operable to control an action of the robot body.

18. The mobile robot system of claim 1, wherein the robot body further comprises a second robotic arm, the second robotic arm mechanically coupled to the torso.

19. The mobile robot system of claim 1, wherein the mobile base further comprises a propulsion system, the propulsion system operable to cause a motion of the mobile base.

20. The mobile robot system of claim 1, wherein the mobile base is capable of autonomous movement.
